(19) United States
(12) Patent Application Publication
(10) Pub. No.: US 2026/0342874 A1
(43) Pub. Date: Oct. 29, 2026

(54) METHOD, DEVICE, AND COMPUTER PROGRAM PRODUCT FOR PROCESSING DATA

(71) Applicant: DELL PRODUCTS L.P., ROUND ROCK, TX (US)

(72) Inventors: Jinjin Wang, Shanghai (CN); Mengze Liao, Shanghai (CN); Yuanyi Liu, Shanghai (CN); Weiyang Liu, Shanghai (CN)

(21) Appl. No.: 19/233,900

(22) Filed: Jun. 10, 2025

(30) Foreign Application Priority Data
Apr. 24, 2025 (CN) 202510525427.1

(51) Int. Cl. H04L 67/1095

(52) U.S. Cl. CPC H04L 67/1095

(57) ABSTRACT

The present disclosure relates to a method, a device, and a computer program product for processing data. The method includes determining candidate distribution data and a data state of the candidate distribution data based on a collected target data record and a historical data record. The method further includes determining, based on the data state, data fields in the candidate distribution data that are to be distributed as distribution fields. The method further includes processing the distribution fields to generate distribution data. This method can effectively remove redundant data to improve the quality of data, while also effectively reducing bandwidth consumption and reducing network latency.

### TECHNICAL FIELD

The present disclosure generally relates to the field of data storage and, more particularly, to a method, a device, and a computer program product for processing data.

### BACKGROUND

In distributed data analysis scenarios, parameters of a measured object (e.g., a device, a system, or an environment) at a certain distance are typically collected, transmitted, and processed by means of tools such as sensors and software. By continuously collecting multi-source real-time data (e.g., device status, environmental metrics, etc.), foundational support is provided for operational monitoring and decision optimization.

In some scenarios, historical data from multiple devices or systems in different regions needs to be collected and analyzed to generate comprehensive reports. These reports provide not only real-time system status but also temporal analysis. For example, by integrating historical data such as device operation logs and energy consumption records from different regions, comprehensive analytical reports incorporating temporal dimensions can be generated. Such reports not only reflect real-time status but also reveal long-term behavioral patterns of systems through time series analysis (e.g., trend prediction, periodic fluctuation detection). Therefore, retaining historical data enables understanding of long-term trends and lifecycle events, thus facilitating accurate decision-making in resource allocation, capacity planning, and policy adjustments.

### SUMMARY OF THE INVENTION

Embodiments of the present disclosure propose a method, a device, and a computer program product for processing data.

In a first aspect of the embodiments of the present disclosure, a method for processing data is provided. The method includes determining candidate distribution data and a data state of the candidate distribution data based on a collected target data record and a historical data record. The method further includes determining, based on the data state, data fields in the candidate distribution data that are to be distributed as distribution fields. The method further includes processing the distribution fields to generate distribution data.

In a second aspect of the embodiments of the present disclosure, an electronic device is provided. The electronic device includes: at least one processor; and a storage apparatus for storing one or more programs, where the one or more programs, when executed by one or more processors, cause the one or more processors to implement a method for processing data. The method includes determining candidate distribution data and a data state of the candidate distribution data based on a collected target data record and a historical data record. The method further includes determining, based on the data state, data fields in the candidate distribution data that are to be distributed as distribution fields. The method further includes processing the distribution fields to generate distribution data.

In a third aspect of the embodiments of the present disclosure, a computer-readable storage medium is provided that has a computer program stored thereon, where the program, when executed by a processor, implements a method for processing data. The method includes determining candidate distribution data and a data state of the candidate distribution data based on a collected target data record and a historical data record. The method further includes determining, based on the data state, data fields in the candidate distribution data that are to be distributed as distribution fields. The method further includes processing the distribution fields to generate distribution data.

It should be understood that the content described in the Summary of the Invention section is neither intended to limit key or essential features of the embodiments of the present disclosure, nor intended to limit the scope of the present disclosure. Other features of the present disclosure will become readily understood from the following description.

### BRIEF DESCRIPTION OF THE DRAWINGS

The above-mentioned and other features, advantages, and aspects of the embodiments of the present disclosure will become more apparent with reference to the accompanying drawings and the following detailed description. In the accompanying drawings, identical or similar reference numerals represent identical or similar elements, in which:

FIG. 1 illustrates a schematic diagram of an example environment in which some embodiments of the present disclosure may be implemented;

FIG. 2 illustrates a flow chart of a method for processing data according to some embodiments of the present disclosure;

FIG. 3 illustrates a flow chart of a process for determining a data state of candidate distribution data according to some embodiments of the present disclosure;

FIG. 4A illustrates a schematic diagram of data retransmission according to some embodiments of the present disclosure;

FIG. 4B illustrates a schematic diagram of data retransmission according to some other embodiments of the present disclosure;

FIG. 5 illustrates a schematic diagram of a system for processing data according to some embodiments of the present disclosure;

FIG. 6 illustrates a schematic diagram of an optimization processing component according to some embodiments of the present disclosure; and

FIG. 7 illustrates a block diagram of a device according to some embodiments of the present disclosure.

### DETAILED DESCRIPTION

The embodiments of the present disclosure will be described in more detail below with reference to the accompanying drawings. Although some embodiments of the present disclosure are illustrated in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and embodiments of the present disclosure are for illustrative purposes only, and are not intended to limit the scope of protection of the present disclosure.

In the description of embodiments of the present disclosure, the term “include” and similar terms thereof should be understood as open-ended inclusion, i.e., “including but not limited to.” The term “based on” should be understood as “based at least in part on.” The term “an embodiment” or “the embodiment” should be construed as “at least one embodiment.” The terms “first,” “second,” and the like may refer to different or the same objects. Other explicit and implicit definitions may also be included below.

In some scenarios, it is necessary to rely on a data collection system to collect various telemetry data from geographically dispersed data sources and reliably transmit them to a central repository to generate reports providing real-time status and temporal analysis. For example, in some scenarios, users need to track metrics such as usage of their purchased licensed capacity, monitor storage trends, and analyze resource consumption patterns to optimize their operational models and plan future demands.

However, collecting and processing large volumes of telemetry data from geographically dispersed data sources poses challenges. In the related art, one or more data collectors are employed to collect telemetry data from remote systems located at different geographic locations. These data collectors send the collected data to a data processing platform (e.g., an OpenTelemetry platform). Subsequently, the platform forwards the data to exporters, which ultimately store the data in a database within a demilitarized zone. Due to reliance on centralized infrastructure, conventional centralized telemetry systems suffer from problems of high latency, bandwidth constraints, and poor fault tolerance.

For example, for periodic data collection tasks, data is collected at time point 1 of each data collection cycle and then transmitted to a central database. At time point 1 (e.g., 00:00), the data collector collects data 1, but due to temporary network issues or a database outage, the exporter fails to save data 1 to the central database. At time point 2 (e.g., 04:00), the configuration of data 1 changes, which is recorded as data 1′. At time point 3 (e.g., 06:00), the exporter finally detects the loss of data at time point 1 (i.e., data 1). However, since data 1 has changed over time, it is no longer possible to query the state of data 1 at time point 1.

It can be seen that, due to API function limitations in data collection systems, it is often difficult to detect data changes or deletions. Related methods typically adopt two approaches for data collection: one involves collecting complete datasets, and the other involves collecting incremental data. However, each strategy has its limitations.

According to the approach of collecting complete datasets, within each data collection cycle, the entire dataset may be directly saved to the database. Although this ensures data integrity, unchanged redundant data generated from resources persistently occupies storage space. Additionally, pulling full datasets across regions or under bandwidth-constrained conditions can easily lead to supersaturation of network resources. Furthermore, an excessively large amount of stored data may exacerbate query latency, thereby impacting user experience.

According to the approach of collecting incremental data, within each data collection cycle, the collected data is filtered by timestamps and only updated data is transmitted. Although this can reduce data volume and storage requirements, it cannot identify deleted resources.

Resource group data of a system over two consecutive days is shown below as an example. For simplified representation, for unchanged fields, “**” is used to denote values of the fields.

```
resource-group on Jun 7^{th}
{
  “content”: [
    {
      “id”: 11,
      “name”: **,
      “description”: **,
      “createdBy”: **,
      “createdAt”: **,
      “updatedAt”: **,
      “numberOfResources”: **,
    },
    {
      “id”: 22,
      “name”: **,
      “description”: **,
      “createdBy”: **,
      “createdAt”: **,
      “updatedAt”: **,
      “numberOfResources”: **,
    },
    {
      “id”: 33,
      “name”: **,
      “description”: **,
      “createdBy”: **,
      “createdAt”: **,
      “updatedAt”: “2023-06-07T15:01:55.871Z”,
      “numberOfResources”: **,
    }
  ]
}
resource-group on Jun 8^{th}
{
  “content”: [
    {
      “id”: 11,
      “name”: **,
      “description”: **,
      “createdBy”: **,
      “createdAt”: **,
      “updatedAt”: **,
      “numberOfResources”: **,
    },
    {
      “id”: 33,
      “name”: **,
      “description”: **,
      “createdBy”: **,
      “createdAt”: **,
      “updatedAt”: “2023-06-08T10:15:21.642Z”,
      “numberOfResources”: **,
    }
  ]
}
```

In the above example, on June 7, the system contains 3 resource group records corresponding to ids 11, 22, and 33, respectively. On June 8, the system contains 2 resource group records corresponding to ids 11 and 33, respectively, where the 2nd resource group has been deleted. Additionally, from the updateAt field of the third resource group (33), it can be seen that this resource group has been updated.

Since the resource group belongs to time-sensitive resources, its API provides an “updateAt” field, which allows querying new or updated data. Therefore, if the data collector acquires incremental data, it can query updated records (e.g., the update to the third resource group can be found through the query). However, it cannot detect deleted records. On this basis, the system ultimately displays obsolete or incorrect data.

To this end, the embodiments of the present disclosure provide a solution for processing data. By comparing a collected target data record and a historical data record at a data collector end first, candidate distribution data and the data state thereof are dynamically determined. Data states may be unchanged, newly created, deleted, updated, etc. Afterwards, for different data states, data fields in the candidate distribution data that are to be distributed are determined. This approach can reduce the volume of stored and transmitted data while ensuring retention of only the most relevant data, thereby improving processing efficiency. Afterwards, the distribution fields are processed according to certain rules to generate distribution data, which is transmitted to downstream systems (e.g., a data processing platform, a central database, etc.), thereby reducing network overhead.

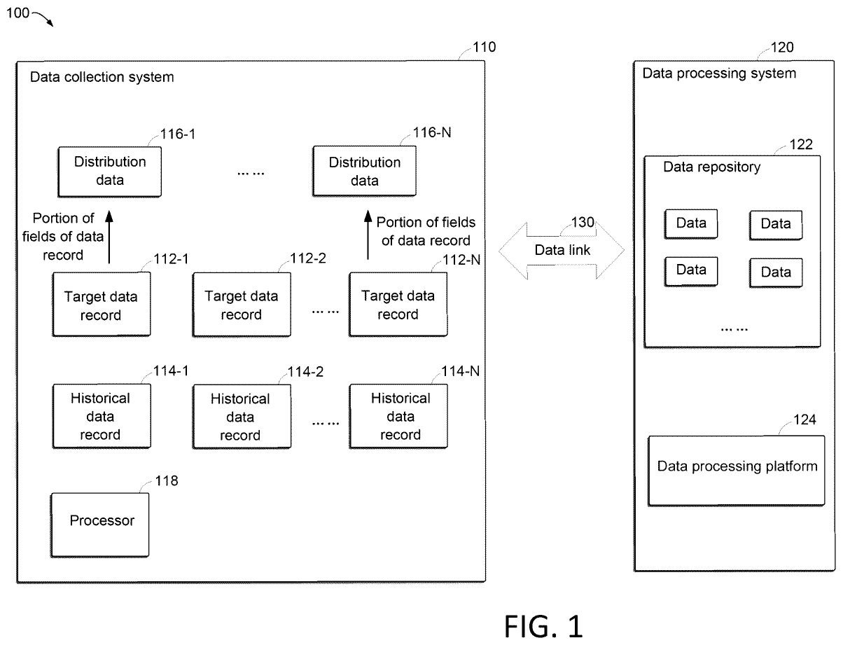

FIG. 1 illustrates a schematic diagram of an example environment 100 in which some embodiments of the present disclosure may be implemented. With reference to FIG. 1, the environment 100 includes a data collection system 110 and a data processing system 120. The data collection system 110 collects various data from geographically dispersed data sources, including, for example, environmental data, location data, device operation status data, data related to system operating indicators (e.g., system error rate, CPU utilization, or service request rate), and the like. In a data collection task, one or more pieces of data may be included. According to implementations of the present disclosure, one piece of data collected is referred to as a data record. As shown in FIG. 1, the data collection system 110 includes target data records 112-1, 112-2, . . . , 112-N (collectively or individually referred to as target data record 112), which are data records collected in the current data collection task. The data collection system 110 further includes historical data records 114-1, 114-2, . . . , 114-N (collectively or individually referred to as historical data record 114), which are data records collected in previous data collection tasks. In the environment 100, data to be distributed (abbreviated as “distribution data”), i.e., distribution data 116-1, . . . , 116-N (collectively or individually referred to as distribution data 116), is determined based on the target data record 112 and the historical data record 114. The distribution data 116 may include a complete data record, or may include a portion of fields of a data record. It should be noted that although “N” is used here to denote multiple, this does not limit that the target data record 112, the historical data record 114, and the distribution data 116 to have the same quantity.

With reference to FIG. 1, in the environment 100, the data collection system 110 includes a processor 118. The processor 118 may perform operations related to data processing and storage management, for example, data access, data compression and decompression, data replication, and some computational tasks.

With reference to FIG. 1, in the environment 100, a data link 130 may be used to transmit data between the data collection system 110 and the data processing system 120. For example, the data link 130 may be used to transmit the distribution data 116 from the data collection system 110 to the data processing system 120.

The data processing system 120 is responsible for storing and processing the received data (e.g., the distribution data 116). With reference to FIG. 1, the data processing system 120 may include a data repository 122, a data processing platform 124, and the like. Taking the data repository 122 as an example, it stores multiple pieces of data. In the data repository 122, the distribution data 116 may be stored in other manners, which are not elaborated here. The data processing platform 124 may process the stored data based on information such as data identifiers and data states to obtain analysis results desired by users.

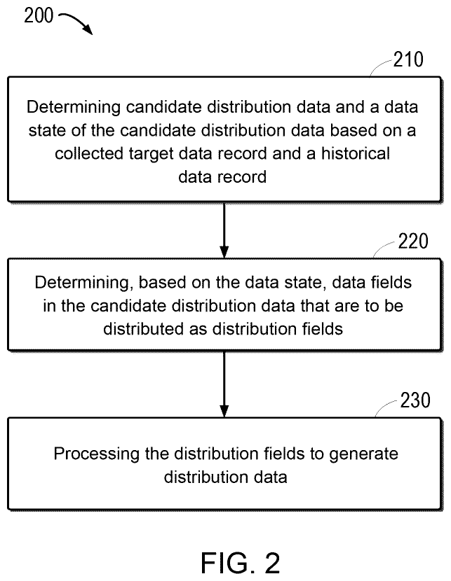

FIG. 2 illustrates a flow chart of a method 200 for processing data according to some embodiments of the present disclosure. According to an implementation of the present disclosure, the method 200 is configured to be executed in the aforementioned data collection system 110. It should be understood that the description of the method 200 and the description of the aforementioned environment 100 are complementary to each other, and overlapping details will not be repeated here.

At 210, candidate distribution data and a data state of the candidate distribution data are determined based on a collected target data record and a historical data record. According to an implementation of the present disclosure, a data record from a previous data collection task is stored as a historical data record. In this way, when a new target data record is subsequently obtained, the target data record and the stored historical data record may be combined to rapidly determine data that is likely to be distributed to downstream systems (i.e., candidate distribution data). In other words, the candidate distribution data may include one or more historical data records in addition to the target data record. Meanwhile, the data state of the candidate distribution data is determined by comparing information of the candidate distribution data in the target data record and the historical data record. Put simply, if the information of the candidate distribution data is consistent between the target data record and the historical data record, it indicates that the data state of the candidate distribution data is unchanged. Conversely, if the information of the candidate distribution data is inconsistent between the target data record and the historical data record, it indicates that the data state of the candidate distribution data has changed.

At 220, data fields in the candidate distribution data that are to be distributed are determined as distribution fields based on the data state. In other words, whether to distribute all or a portion of fields of the candidate distribution data is determined according to the data state of the candidate distribution data. According to an implementation of the present disclosure, if the data state indicates that the candidate distribution data has not changed, a portion of the fields of the candidate distribution data may be determined as distribution fields to be distributed. If the data state indicates that the candidate distribution data has changed, the type of change (e.g., new creation, deletion, update of a portion of information, etc.) may be further considered to determine whether to distribute all or a portion of fields of the candidate distribution data. For example, in the environment 100 shown in FIG. 1, at least one of the data record and a portion of fields is determined from the target data record 112 and the historical data record 114 as the distribution fields. Here, a “data record” refers to a complete data record, which may be either a target data record or a historical data record.

At 230, the distribution fields are processed to generate distribution data. According to an implementation of the present disclosure, after determining the distribution fields, the distribution fields may be further processed, and the processed distribution fields are used as the distribution data. The processing of the distribution fields primarily involves processing duplicate or similar data fields within the same category of resources to further reduce the volume of data to be transmitted.

Through this approach, the method 200 first identifies candidate distribution data and its data state based on a collected target data record and a historical data record, and then determines distribution fields based on the data state. This not only can accurately represent the data state at any time point but also can effectively remove redundant data, improving data quality, while reducing the volume of data transmitted in the data link 130 shown in FIG. 1, thereby minimizing network bandwidth usage and increasing transmission success rates. Additionally, since only all or a portion of fields of the candidate distribution data are to be distributed, operational burdens on downstream systems (e.g., the data processing system 120 in FIG. 1) are alleviated while providing them with accurate and real-time data states.

In some embodiments, a data record (including a target data record and a historical data record) may contain at least one of the following fields: transaction identifier (used to identify the data collection task to which the data record belongs), resource identifier (used to identify the resource to which the data record belongs), data source identifier (used to identify the data source from which the data record originates), data number (used to identify the sequence number of the data record in a data collection task), timestamp (used to identify the timestamp of the data record), or raw data (used to record data content). In further embodiments, in addition to the above fields, a data record further includes a resource type used to identify the type of resource to which the data record belongs. Resource types may include, for example time-sensitive resource types, such as resource groups, activities, and policies; or non-time-sensitive resource types, such as license information and configuration information. Embodiments of the present disclosure do not limit resource types. In practical applications, resource types may be determined according to application scenarios. Regarding timestamps, in this embodiment, if a data record belongs to a time-sensitive resource type, the temporal information of the data record itself (e.g., updatedAt) is used as the timestamp; if a data record does not belong to a time-sensitive resource type, the time at which the data record is collected is used as its timestamp.

The following illustratively shows a data record. The resource type to which the data record belongs is policy data, and the fields contained therein include: transaction identifier (transaction_id), resource identifier (resource_id), data source identifier (system_id), data number (no), timestamp (resource_time), or raw data (raw_data). An example is as follows:

CREATE TABLE policy data (
transaction_id BLOB NOT NULL, -- Associated with the corresponding transaction table

| | |
|---|---|
| resource_id TEXT NOT NULL, | -- Resource identifier |
| system_id TEXT NOT NULL, | -- Data source identifier |

resource_time BIGINT NOT NULL, -- Resource time

| | |
|---|---|
| no INTEGER NOT NULL, | -- Sequence number of data in the data collection task |
| raw_data JSON NOT NULL, | -- Raw data acquired from API responses |

```
  PRIMARY KEY(transaction_id, resource_id),
  FOREIGN KEY(transaction_id) REFERENCES transaction(transaction id)
);
```

From the above example, when storing the target data record, it is stored based on the resource type of the target data record. In other words, target data records belonging to the same resource type are stored together, for example, in a single data table.

In some embodiments, considering the processing efficiency, a historical data record most relevant to the target data record is first determined from the stored historical data records from multiple collection tasks. For example, the historical data record is determined based on the resource type and a data source identifier of the target data record.

In some embodiments, based on the resource type of the target data record, a historical data record associated with the data source identifier of the target data record is determined from historical data records pointed to by the resource type. In some further embodiments, historical data records associated with the data source identifier of the target data record are first filtered from the historical data records pointed to by the resource type of the target data record; then, the most recent historical data record is further determined from the filtered historical data records based on the timestamp as the final historical data record.

Subsequently, candidate distribution data and its data state may be determined by comparing the target data record and the historical data record. In some embodiments, the candidate distribution data is first determined based on a resource identifier of the historical data record and a resource identifier of the target data record. Then, a data state of the candidate distribution data is determined by comparing whether the candidate distribution data is consistent between the historical data record and the target data record.

For example, the union of the target data record and the historical data record is taken as the candidate distribution data. The following uses Table 1 and Table 2 for illustration. Table 1 illustratively shows historical data records, and Table 2 illustratively shows target data records. It should be understood that these are for illustrative purposes only, and the present disclosure is not limited thereto.

TABLE 1
Historical Data Records

| Data Source | Resource | |
|---|---|---|
| Identifier | Identifier | Raw Data |
| 44c2b89d583d | UUID 1 | {′name′: ′vm_protection′, storage’:′ddve-66’} |
| 44c2b89d583d | UUID 2 | {′name′:′sql_protection′, |
| | | ′storage′:′ddve-34′} |
| 44c2b89d583d | UUID 3 | {′name’:′oracle_protection′, |
| | | ′storage’:′ddve-51’} |

TABLE 2
Target Data Records

| Data Source | Resource | |
|---|---|---|
| Identifier | Identifier | Raw Data |
| 44c2b89d583d | UUID 1 | {′name′: ′vm_protection′, storage’:′ddve-66’} |
| 44c2b89d583d | UUID 2 | {′name′:′sql_protection′, ′storage′:′ddve-55′} |
| 44c2b89d583d | UUID 8 | {′name’:′vm_protection_apj′, |
| | | ′storage’:′ddve-apj-100’} |

By comparing Table 1 and Table 2, it can be determined that the candidate distribution data includes 4 entries, and the corresponding resource identifiers are UUID 1, UUID 2, UUID 3, and UUID 8, respectively.

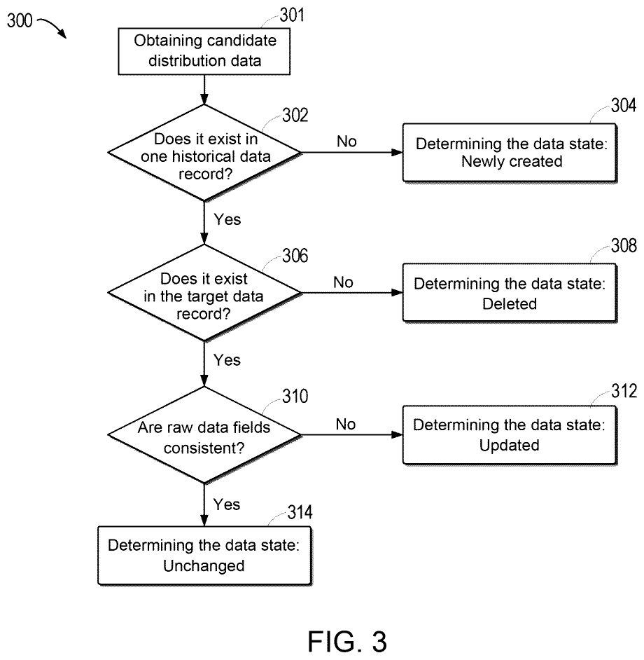

Then, a data state of the candidate distribution data is determined by comparing whether the candidate distribution data is consistent between the target data record and the historical data record. In some embodiments, the data state includes at least one of: Unchanged, Newly created, Deleted, or Updated. FIG. 3 illustrates a flow chart of a process 300 for determining a data state of candidate distribution data according to some embodiments of the present disclosure. With reference to FIG. 3, at block 301, the process 300 obtains candidate distribution data.

At block 302, the process 300 determines whether the candidate distribution data exists in one historical data record. If it is determined that the candidate distribution data does not exist in one historical data record, the process proceeds to block 304, where the process 300 determines that the data state of the candidate distribution data is Newly created. If it is determined that the candidate distribution data exists in one historical data record, the process proceeds to block 306, where the process 300 continues to determine whether the candidate distribution data exists in a target data record. If it is determined that the candidate distribution data does not exist in the target data record, the process proceeds to block 308, where the process 300 determines that the data state of the candidate distribution data is Deleted.

If it is determined that the candidate distribution data exists in the target data record, the process proceeds to block 310, where the process 300 continues to determine whether raw data fields of the candidate distribution data in the historical data record are consistent with its raw data fields in the target data record. If inconsistent, the process proceeds to block 312, where the process 300 determines that the data state of the candidate distribution data is Updated. If it is determined that the raw data fields of the candidate distribution data in the historical data record are consistent with its raw data fields in the target data record, the process proceeds to block 314, where the process 300 determines that the data state of the candidate distribution data is Unchanged.

It should be noted that embodiments of the present disclosure do not limit the sequential order of block 302 and block 306 and their branches in the process 300. In applications, block 306 may also be performed first to determine whether the candidate distribution data exists in the target data record. When it is determined that the candidate distribution data exists in the target data record, block 302 is executed to determine whether the candidate distribution data exists in one historical data record. These are not enumerated here one by one.

Continuing with the previous example, the process 300 is executed for each piece of candidate distribution data to determine its data state. For candidate distribution data UUID1, since its raw data fields in Table 1 and Table 2 are consistent, the data state of UUID1 is Unchanged. For candidate distribution data UUID2, since its raw data fields in Table 1 and Table 2 are inconsistent, the data state of UUID2 is Updated. For candidate distribution data UUID3, since it exists in Table 1 and does not exist in Table 2, the data state of UUID3 is Deleted. For candidate distribution data UUID8, since it does not exist in Table 1 and exists in Table 2, the data state of UUID8 is Newly created. Table 3 shows the candidate distribution data and the data state of each piece of candidate distribution data.

TABLE 3
Candidate Distribution Data and Their Data States

| Data Source | Resource | | |
|---|---|---|---|
| Identifier | Identifier | Data State | Raw Data |
| 44c2b89d583d | UUID 1 | Unchanged | {′name′: ′vm_protection′, |
| | | | storage’:′ddve-66’} |
| 44c2b89d583d | UUID 2 | Updated | {′name′:′sql_protection′, |
| | | | ′storage′:′ddve-55′} |
| 44c2b89d583d | UUID 8 | Newly | {′name’:′vm_protection_apj′, |
| | | Created | ′storage’:′ddve-apj-100’} |
| 44c2b89d583d | UUID 3 | Deleted | |

For some systems that do not directly support incremental extraction or resource deletion detection, through the above approach, the candidate distribution data can be dynamically determined and their data states can be identified.

In some embodiments, the following manner is adopted to determine distribution fields based on the data state. If the data state is Unchanged, the distribution fields are determined as a resource identifier of the candidate distribution data and the data state. If the data state is Newly created, the distribution fields are determined as all fields of the candidate distribution data and the data state. If the data state is Deleted, the distribution fields are determined as the resource identifier of the candidate distribution data and the data state. If the data state is Updated, the distribution fields are determined based on the resource type to which the target data record belongs. In other words, for candidate distribution data with data states of “Unchanged” and “Deleted,” only their resource identifiers and data states need to be distributed. For candidate distribution data with a data state of “Newly created,” all fields and the data state need to be distributed together.

For candidate distribution data with a data state of “Updated,” further processing is required. Its distribution fields are determined based on the resource type to which the target data record belongs. For most resources, most fields remain unchanged once created, with only a small portion of fields being mutable. In an embodiment according to the present disclosure, corresponding rules are set for each resource type. These rules classify fields into immutable fields and mutable fields, such that when the data state is “Updated,” only the updated mutable fields are sent.

For the mutable fields, further differentiation can be made based on an update frequency. The following illustrates a manner of determining distribution fields when the data state is “Updated” according to some embodiments of the present disclosure. First, based on the resource type, a first field and a second field indicating different update frequencies are determined. In some embodiments, the first field refers to occasionally updated fields, and the second field refers to frequently updated fields. In other words, the update frequency of the first field is lower than that of the second field. Subsequently, at least one of a checksum of the first field (denoted as checksum1) and a checksum of the second field (denoted as checksum2) is determined, and then the distribution fields are determined based on the determined checksum.

According to some embodiments, whether the distribution fields include the first field is determined by comparing whether the checksum of the first field is consistent with a pre-stored checksum. The pre-stored checksum is generated based on a historical checksum of the first field pointed to by the resource type. For example, checksum1 is calculated. If checksum1 is consistent with the corresponding pre-stored checksum (denoted as checksum1′), it is determined that the distribution fields do not include the first field. At this time, the second field and the data state are directly determined as the distribution fields. Meanwhile, checksum1′ is updated with the currently calculated checksum1 to serve as the pre-stored checksum for the first field, waiting for the next match. If the calculated checksum1 is inconsistent with checksum1′, the first field, the second field, and the data state may be determined as the distribution fields. This means that no additional checksum calculation is required for the frequently updated second field to minimize latency.

When the calculated checksum1 is inconsistent with checksum1′, the checksum checksum2 of the second field may also be calculated, and whether checksum2 is consistent with the corresponding pre-stored checksum (denoted as checksum2′) is determined. If consistent, the first field and the data state are determined as the distribution fields. Meanwhile, checksum1′ is updated with the currently calculated checksum1 to serve as the pre-stored checksum for the first field, and checksum2′ is updated with the currently calculated checksum2 to serve as the pre-stored checksum for the second field, waiting for the next match.

According to the manner of determining distribution fields based on data states in the present disclosure, transmitted data can be reduced. Moreover, when the data state is Updated, adopting different approaches to determine distribution fields for fields with different update frequencies not only can reduce network overhead but also can improve processing efficiency.

Continuing with the previous example, Table 4 shows the distribution fields for the candidate distribution data in Table 3. Comparing Table 4 with Table 2, compared with directly transmitting newly collected data records to downstream systems, this solution not only identifies deleted data and transmits its data state to downstream systems, but also filters out redundant data and streamlines distribution fields. In this way, both the accuracy of data and timely update of the data state can be ensured, while reducing storage amounts and improving data processing efficiency.

TABLE 4
Distribution Fields

| Resource Identifier | Data State | Data Field |
|---|---|---|
| UUID 1 | Unchanged | |
| UUID 2 | Updated | {′storage′:′ddve-55′} |
| UUID 8 | Newly Created | {′name’:′vm_protection_apj′, |
| | | ′storage’:′ddve-apj-100’} |
| UUID 3 | Deleted | |

According to some embodiments of the present disclosure, in some scenarios, up to 150,000 activity events (creation or update) and 300,000 daily replication events (creation, update, or deletion) occur per day. By processing the target data record through the aforementioned manner to obtain streamlined data fields to be distributed, bandwidth usage can be significantly reduced, and database resource consumption can be lowered.

The following illustratively shows two resource types, where the aforementioned manner is adopted to determine their distribution fields. It can be seen that the processed data volume is significantly reduced.

### Example 1 Activity Event

When an activity event is marked as completed, most fields are immutable. Some fields, such as stats, hasLog, and updatedAt, may still be occasionally updated.

For an original activity event, all its resource data (approximately 4697 bytes, for example) includes many immutable fields. As shown below:

```
{
  “payloadType”:“activity”,
  “id”:“9bf50eb0-dbc5-4860-9932-e4e9da890056”,
  “state”:“Update”,
  “body”:{
    “id”:“9bf50eb0-dbc5-4860-9932-e4e9da890056”,
    “name”:“Configuring Protection for VM”,
    “category”:“CONFIG”,
    “subcategory”:“ASSET_CONFIGURATION”,
    “parentId”:“69fc9286-a24b-4a99-b3e4-6632e5478eec”,
    “classType”:“TASK”
    ......
    ......
    ......
    ......
    “hasLogs”:true,
    “protectionPolicy”:{
      “id”:“f01030c3-101a-491f-8f16-ae25800191db”,
      “name”:“VM-D41-PROD-4”
    }
    “asset”:{
      “id”:“50a96bd4-fa12-5e5a-973c-46d5a6750ba8”,
      “name”:“fuxi-prd-dr-a”
    },
    “inventorySource”:{
      “id”:“8a875978-6114-5fb9-81a7-9886382176c9”,
      “name”:“vcenter-d41.siag.it”
    },
    “stats”:{
      “numberOfAssets”:1
    }
    ......
    “timestamp”:“2024-08-12T01:01:19.363Z”
}
```

When confirming that the data state is “Updated,” hasLog and stats are determined as distribution fields. The data of the distribution fields (approximately 248 bytes, for example) is as follows:

```
{
  “payloadType”:“activity”,
  “id”:“9bf50eb0-dbc5-4860-9932-e4e9da890056”,
  “state”:“Update”,
  “body”:{
      “stats”:{
      “numberOfAssets”:1
      },
      “hasLogs”:true,
    },
    “timestamp”:“2024-08-12T01:01:19.363Z”
}
```

### Example 2: Backup Event

When a backup event is created, most fields are immutable, including id, createdAt, and backupLevel. A small portion of fields, such as sizeInBytes, updatedAt, state, and nested fields in retention (e.g., expiresAt, lockStatus) may still change.

For an original backup event, all its resource data (approximately 3989 bytes, for example) includes many immutable fields. As shown below:

```
{
  “payloadType”:“copy”,
  “id”:“00000a35-668e-5cf8-9ba1-be026263f29a”,
  “state”:“Update”,
  “body”:{
    “assetType”: “MICROSOFT_SQL_DATABASE”,
    “id”: “00000a35-668e-5cf8-9ba1-be026263f29a”,
    “name”: “(replica-39741e48)Storage”, .....
    .....
    .....
    .....
      “sizeInBytes”: 92672,
      “state”: “IDLE”,
      “retention”: {
        “expiresAt”: “2024-09-27T00:00:00Z”,
        “lockStatus”: “ALL_COPIES_UNLOCKED”
      }
      .....
    },
    “timestamp”:“2024-09-23T11:43:56.166Z”
}
```

When confirming that the data state is “Updated,” sizeInBytes, retention, and state are determined as distribution fields. The data of the distribution fields (approximately 384 bytes, for example) is as follows:

```
{
  “payloadType”:“copy”,
  “id”:“00000a35-668e-5cf8-9ba1-be026263f29a”,
  “state”:“Update”,
  {
      “sizeInBytes”: 92672,
      “state”: “IDLE”,
      “retention”: {
        “expiresAt”: “2024-09-27T00:00:00Z”,
        “lockStatus”: “ALL_COPIES_UNLOCKED”
      }
  } ,
    “timestamp”:“2024-09-23T11:43:56.166Z”
  }
```

In some embodiments, when generating the distribution data, distribution fields are processed based on the resource type. For example, distribution fields belonging to the same resource type are packaged, compressed, or otherwise processed to generate the distribution data. This method proves particularly effective when processing repetitive or similar data fields within the same resource, as it can significantly improve the compression ratio.

When compressing data of different resource types, by comparing data volumes before and after compression, it can be seen that compressing distribution fields can effectively reduce the volume of transmitted data, thereby ensuring efficient data transmission. As shown in Table 5.

TABLE 5
Data Volume Comparison Before and After Compression

| Resource Type | Original Size | Compressed Size | Compression Ratio |
|---|---|---|---|
| Activity Event | 156M | 23M | 0.15 |
| Backup Event | 194M | 34M | 0.17 |
| Asset | 12M | 1.1M | 0.09 |

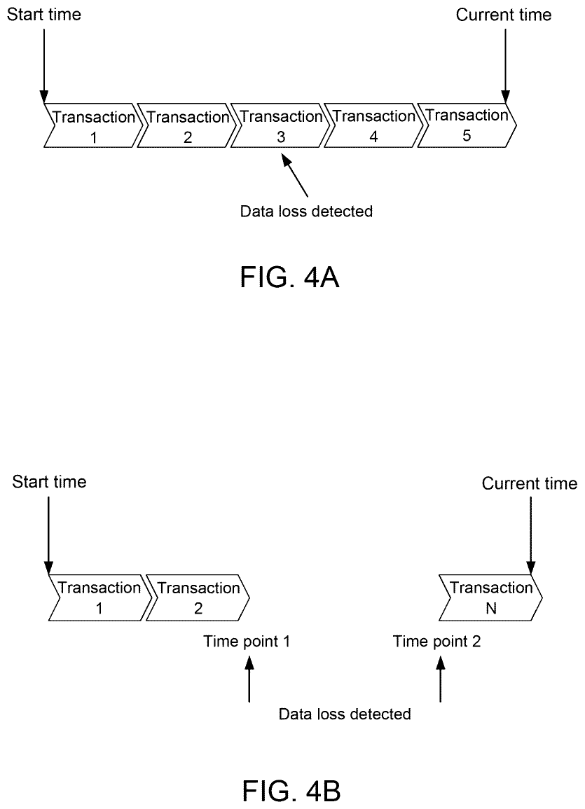

The method 200 according to the present disclosure further supports a data retransmission mechanism. According to embodiments of the present disclosure, this mechanism supports two primary scenarios: partial data loss in a transaction and data loss within a specific time range. FIGS. 4A and 4B illustrate schematic diagrams of data retransmission under these two scenarios.

With reference to FIG. 4A, a downstream system detects loss of a portion of data in Transaction 3, for example, missing data with data numbers 12, 54, and 207. In some embodiments, a request from a downstream system for retransmitting missing data is received, where the request includes a transaction identifier and a data number of the missing data. As described previously, data records collected each time may be stored, for example, in a data table. Thus, upon receiving the request, the missing data can be retrieved from the stored data records based on the transaction identifier and the data number. Subsequently, the retrieved missing data is sent to the downstream system.

Referring to FIG. 4B, the downstream system detects data loss from time point 1 (e.g., 2024-12-20-16:15) to time point 2 (e.g., 2024-12-20-17:15). In some embodiments, a request from a downstream system for retransmitting missing data is received, where the request includes the data source identifier, resource type, and data loss time period that are pointed to by the missing data. Subsequently, the missing data is retrieved based on the data source identifier, the resource type, a timestamp, and the data loss time period. For example, the missing data is retrieved based on the fields of the missing data (the data source identifier, the resource type, and the data loss time period) and timestamps of the stored data records. Subsequently, the retrieved missing data is sent to the downstream system. This approach ensures accurate retrieval of the lost data within a specified time window.

According to the method 200 of the present disclosure, target data records collected each time are streamlined and stored based on data states, thereby ensuring the integrity and accuracy of the collected data. When a failure occurs in a database, data exporter, or even a network link in a distributed environment, this solution can support data retransmission, guaranteeing zero data loss in any failure scenario.

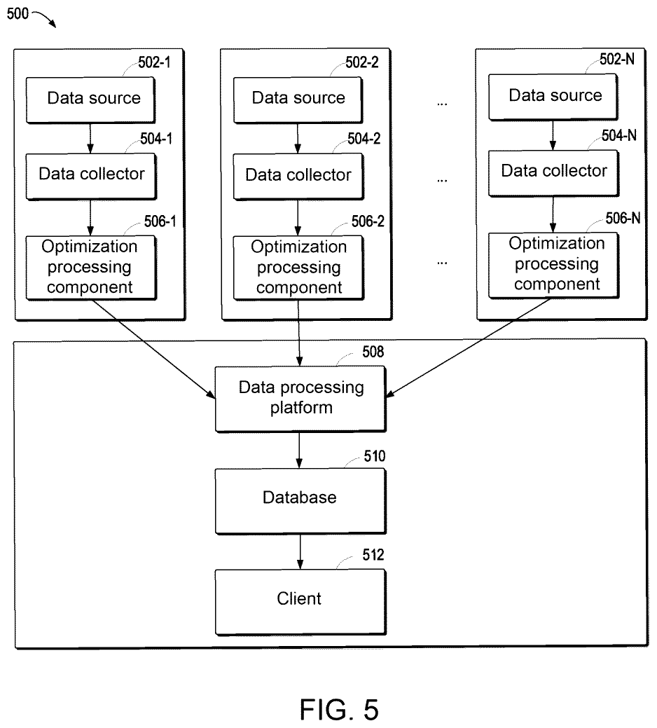

FIG. 5 illustrates a schematic diagram of a system 500 for processing data according to some embodiments of the present disclosure. The system 500 includes a data source 502, a data collector 504, and an optimization processing component 506 that are arranged at a data source side, and a data processing platform 508, a database 510, and a client 512 that are arranged within a demilitarized zone (DMZ).

The data source 502 (e.g., data sources 502-1, 502-2, . . . , 502-N as shown in FIG. 5, collectively or individually referred to as data source 502) may be distributed across different regions and may be implemented as devices, systems, or environments. The data collector 504 (e.g., data collectors 504-1, 504-2, . . . , 504-N as shown in FIG. 5, collectively or individually referred to as data collector 504) is disposed near the data source 502 to collect data from one or more nearby data sources 502. The optimization processing component 506 (e.g., optimization processing components 506-1, 506-2, . . . , and 506-N as shown in FIG. 5, collectively or individually referred to as optimization processing component 506) is communicatively connected to the data collector 504, and generates distribution data by preprocessing data collected by the data collector 504. In some embodiments, the preprocessing includes, for example, data aggregation, state detection, data cleansing, data filtering, data compression, and the like. By preprocessing the data before distribution, redundant data can be effectively removed to improve the quality of the data. Distributing the preprocessed data to downstream systems can reduce bandwidth consumption and decrease network latency. In some embodiments, the preprocessing may refer to related steps in the aforementioned method 200, and redundant details are not repeated here.

The optimization processing component 506 distributes the distribution data to the downstream data processing platform 508. The data processing platform 508 (e.g., an OpenTelemetry platform) may transmit the distribution data originated from different data sources 502 to the database 510 in specific signal forms. The database 510 is communicatively connected to the client 512. In some embodiments, the client 512 may display analysis results of data (i.e., the aforementioned telemetry data) stored in the database to users through visual interfaces. The analysis results may include, for example, real-time status, time series analysis, change trends, etc., and may be presented to users in various forms such as bar charts, lists, histograms, line graphs, etc. Users may also interact through the client 512. For example, a user may request a data query from the database 510 through inputting key fields, so as to obtain desired results. Through this approach, storing the preprocessed distribution data to the database 510 not only can reduce storage costs but also can improve query performance and user experience.

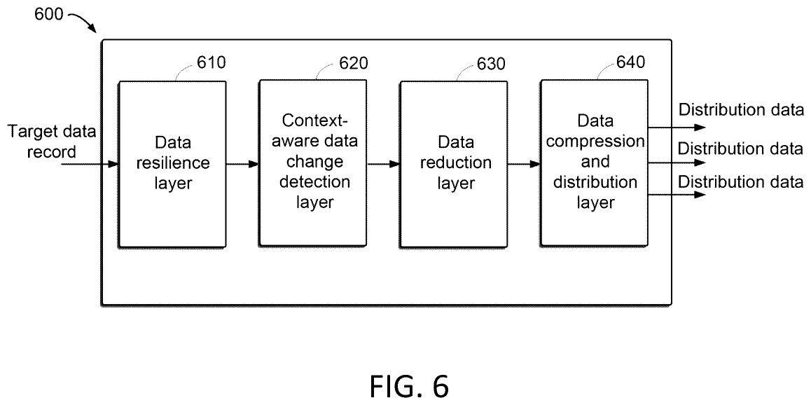

FIG. 6 illustrates a schematic diagram of an optimization processing component 600 according to some embodiments of the present disclosure. It should be noted that the optimization processing component 600 and the aforementioned method 200 are complementary to each other, and overlapping details are not repeated. With reference to FIG. 6, the optimized processing component 600 includes a data resilience layer 610, a context-aware data change detection layer 620, a data reduction layer 630, and a data compression and distribution layer 640.

The data collector collects a target data record from the data source and stores the target data record to the data resilience layer 610. The data resilience layer relies on, for example, lightweight databases such as H2 or SQLite. For each resource type, a dedicated table is created to store data records within a predetermined time period (e.g., N days).

To provide time-series reports, a user needs to analyze the state of the system at any time point within a past period of time (e.g., 18 months). Retaining all collected data records would lead to excessive storage and computational costs, especially for resources that rarely change. Therefore, a context-aware data change detection layer 620 retains only increments (changes) in the data records by determining data states. In some embodiments, the context-aware data change detection layer 620 determines candidate distribution data and a data state of the candidate distribution data based on a collected target data record and a historical data record.

The main purpose of the data reduction layer 630 is to minimize transmitted data and reduce bandwidth consumption. In some embodiments, the data reduction layer 630 determines, based on the data state, data fields in the candidate distribution data that are to be distributed as distribution fields.

The data compression and distribution layer 640 processes large volumes of resources through packaging and compression to optimize bandwidth usage and ensure efficient data transmission. In some embodiments, the data compression and distribution layer 640 processes the distribution fields to generate distribution data.

In a data retransmission scenario, the optimization processing component 600 receives a request from a downstream system for retransmitting missing data, where the request includes fields of the missing data. Subsequently, the missing data is retrieved from the data resilience layer 610 based on the fields of the missing data. Subsequently, the retrieved missing data is sent to the downstream system. In some embodiments, the fields of the missing data include a transaction identifier and a data number of the missing data. In some other embodiments, the fields of the missing data include the data source identifier, resource type, and data loss time period that are pointed to by the missing data.

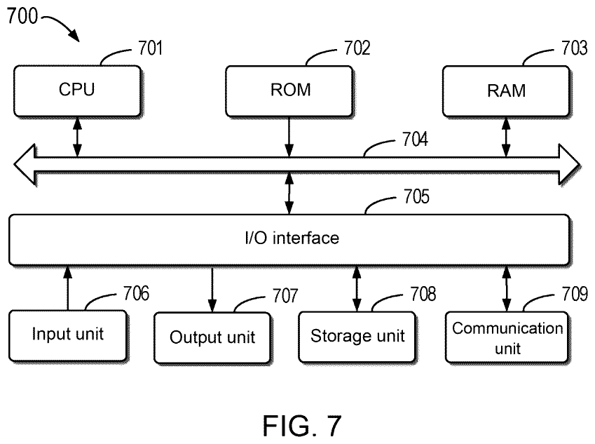

FIG. 7 illustrates a schematic block diagram of an example device 700 which can be used to implement embodiments of the present disclosure. As shown in the figure, the device 700 includes a computing unit 701 that can perform various appropriate actions and processing according to computer program instructions stored in a read-only memory (ROM) 702 or computer program instructions loaded from a storage unit 708 to a random access memory (RAM) 703. Various programs and data required for the operation of the device 700 may also be stored in the RAM 703. The computing unit 701, the ROM 702, and the RAM 703 are connected to each other via a bus 704. An Input/Output (I/O) interface 705 is also connected to the bus 704.

Multiple components in the device 700 are connected to the I/O interface 705, including: an input unit 706, such as a keyboard and a mouse; an output unit 707, such as various types of displays and speakers; the storage unit 708, such as a magnetic disk and an optical disc; and a communication unit 709, such as a network card, a modem, and a wireless communication transceiver. The communication unit 709 allows the device 700 to exchange information/data with other devices via a computer network, such as the Internet, and/or various telecommunication networks.

The computing unit 701 may be various general-purpose and/or special-purpose processing components with processing and computing powers. Some examples of the computing unit 701 include, but are not limited to, central processing units (CPUs), graphics processing units (GPUs), various specialized artificial intelligence (AI) computing chips, various computing units for running machine learning model algorithms, digital signal processors (DSPs), and any appropriate processors, controllers, microcontrollers, etc. The computing unit 701 performs various methods and processing described above, such as the method 200. For example, in some embodiments, the method 200 may be implemented as a computer software program that is tangibly included in a machine readable medium, such as the storage unit 708. In some embodiments, part or all of the computer program may be loaded and/or installed onto the device 700 via the ROM 702 and/or the communication unit 709. When the computer program is loaded to the RAM 703 and executed by the computing unit 701, one or more steps of the method 200 described above may be performed. Alternatively, in other embodiments, the computing unit 701 may be configured to implement the method 200 in any other suitable manners (such as by means of firmware).

The functions described hereinabove can be performed at least in part by one or more hardware logic components. For example, non-restrictively, demonstration types of hardware logic components that can be used include Field Programmable Gate Arrays (FPGAs), Application Specific Integrated Circuits (ASICs), Application Specific Standard Products (ASSPs), Systems On Chip (SOC), Load Programmable Logic Devices (CPLDs), etc.

Program codes for implementing the method of the present disclosure may be written by using one programming language or any combination of multiple programming languages. The program codes may be provided to a processor or controller of a general purpose computer, a special purpose computer, or another programmable data processing apparatus, such that the program codes, when executed by the processor or controller, cause the functions/operations specified in the flow charts and/or block diagrams to be implemented. The program codes may be executed completely on a machine, executed partially on a machine, executed partially on a machine and partially on a remote machine as a stand-alone software package, or executed completely on a remote machine or server.

In the context of the present disclosure, a machine-readable medium may be a tangible medium that may include or store a program for use by an instruction execution system, apparatus, or device or in connection with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include one or more wire-based electrical connections, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. Additionally, although operations are depicted in a particular order, it should be understood that such operations are required to be performed in the particular order shown or in a sequential order, or that all illustrated operations should be performed to achieve desirable results. In certain environments, multitasking and parallel processing may be advantageous. Likewise, although the above discussion contains several specific implementation details, these should not be construed as limitations to the scope of the present disclosure. Certain features that are described in the context of separate embodiments may also be implemented in combination in a single implementation. In contrast, various features that are described in the context of a single implementation may also be implemented in multiple implementations separately or in any suitable sub-combination.

Although the present subject matter has been described using a language specific to structural features and/or method logical actions, it should be understood that the subject matter defined in the appended claims is not necessarily limited to the particular features or actions described above. Rather, the specific features and actions described above are merely example forms of implementing the claims.

1. A method for processing data, comprising:
determining candidate distribution data and a data state of the candidate distribution data based on a collected target data record and a historical data record;
determining, based on the data state, data fields in the candidate distribution data that are to be distributed as distribution fields; and
processing the distribution fields to generate distribution data.

2. The method according to claim 1, wherein the data state comprises at least one of: unchanged, newly created, deleted, or updated; and determining, based on the data state, data fields in the candidate distribution data that are to be distributed as distribution fields comprises:
in response to the data state being unchanged, determining the distribution fields as a resource identifier of the candidate distribution data and the data state;
in response to the data state being newly created, determining the distribution fields as all fields of the candidate distribution data and the data state;
in response to the data state being deleted, determining the distribution fields as the resource identifier of the candidate distribution data and the data state; and
in response to the data state being updated, determining the distribution fields based on a resource type to which the target data record belongs.

3. The method according to claim 2, wherein determining the distribution fields based on a resource type to which the target data record belongs comprises:
determining, based on the resource type, a first field and a second field indicating different update frequencies;
determining at least one of a checksum of the first field and a checksum of the second field; and
determining the distribution fields based on the determined checksum.

4. The method according to claim 3, wherein determining the distribution fields based on the determined checksum comprises:
determining whether the distribution fields comprise the first field by comparing whether the checksum of the first field is consistent with a pre-stored checksum, the pre-stored checksum being generated based on a historical checksum of the first field pointed to by the resource type.

5. The method according to claim 2, wherein determining a data state of the candidate distribution data comprises:
in response to determining that the candidate distribution data does not exist in the historical data record, determining the data state as newly created;
in response to determining that the candidate distribution data exists in the historical data record and does not exist in the target data record, determining the data state as deleted;
in response to determining that raw data fields of the candidate distribution data in the historical data record are inconsistent with its raw data fields in the target data record, determining the data state as updated; and
in response to determining that the raw data fields of the candidate distribution data in the historical data record are consistent with its raw data fields in the target data record, determining the data state as unchanged.

6. The method according to claim 1, wherein determining candidate distribution data and a data state of the candidate distribution data based on a collected target data record and a historical data record comprises:
determining the candidate distribution data based on a resource identifier of the historical data record and a resource identifier of the target data record; and
determining the data state of the candidate distribution data by comparing whether the candidate distribution data is consistent between the historical data record and the target data record.

7. The method according to claim 1, further comprising:
determining the historical data record based on a resource type and a data source identifier of the target data record.

8. The method according to claim 1, further comprising:
storing the target data record based on a resource type of the target data record, the target data record comprising at least one of the following fields: transaction identifier, resource identifier, resource type, data source identifier, data number, timestamp, or raw data, wherein the transaction identifier indicates a data collection task to which the target data record belongs.

9. The method according to claim 8, further comprising:
receiving a request from a downstream system for retransmitting missing data, wherein the request comprises the transaction identifier and a data number of the missing data;
retrieving the missing data based on the transaction identifier and the data number; and
sending the retrieved missing data to the downstream system.

10. The method according to claim 8, further comprising:
receiving a request from a downstream system for retransmitting missing data, wherein the request comprises the data source identifier, the resource type, and a data loss time period that are pointed to by the missing data;
retrieving the missing data based on the data source identifier, the resource type, the timestamp, and the data loss time period; and
sending the retrieved missing data to the downstream system.

11. An electronic device, including:
at least one processor; and
a memory coupled to the at least one processor and having instructions stored therein, wherein the instructions, when executed by the at least one processor, cause the electronic device to perform actions comprising:
determining candidate distribution data and a data state of the candidate distribution data based on a collected target data record and a historical data record;
determining, based on the data state, data fields in the candidate distribution data that are to be distributed as distribution fields; and
processing the distribution fields to generate distribution data.

12. The device according to claim 11, wherein the data state comprises at least one of: unchanged, newly created, deleted, or updated; and determining, based on the data state, data fields in the candidate distribution data that are to be distributed as distribution fields comprises:
in response to the data state being unchanged, determining the distribution fields as a resource identifier of the candidate distribution data;
in response to the data state being newly created, determining the distribution fields as all fields of the candidate distribution data;
in response to the data state being deleted, determining the distribution fields as the resource identifier of the candidate distribution data; and
in response to the data state being updated, determining the distribution fields based on a resource type to which the target data record belongs.

13. The device according to claim 12, wherein determining the distribution fields based on a resource type to which the target data record belongs comprises:
determining, based on the resource type, a first field and a second field indicating different update frequencies;
determining at least one of a checksum of the first field and a checksum of the second field; and
determining the distribution fields based on the determined checksum.

14. The device according to claim 13, wherein determining the distribution fields based on the determined checksum comprises:
determining whether the distribution fields comprise the first field by comparing whether the checksum of the first field is consistent with a pre-stored checksum, the pre-stored checksum being generated based on a historical checksum of the first field pointed to by the resource type.

15. The device according to claim 12, wherein determining a data state of the candidate distribution data comprises:
in response to determining that the candidate distribution data does not exist in the historical data record, determining the data state as newly created;
in response to determining that the candidate distribution data exists in the historical data record and does not exist in the target data record, determining the data state as deleted;
in response to determining that raw data fields of the candidate distribution data in the historical data record are inconsistent with its raw data fields in the target data record, determining the data state as updated; and
in response to determining that the raw data fields of the candidate distribution data in the historical data record are consistent with its raw data fields in the target data record, determining the data state as unchanged.

16. The device according to claim 11, wherein determining candidate distribution data and a data state of the candidate distribution data based on a collected target data record and a historical data record comprises:
determining the candidate distribution data based on a resource identifier of the historical data record and a resource identifier of the target data record; and
determining the data state of the candidate distribution data by comparing whether the candidate distribution data is consistent between the historical data record and the target data record.

17. The device according to claim 11, wherein the actions further comprise:
determining the historical data record based on a resource type and a data source identifier of the target data record.

18. The device according to claim 11, wherein the actions further comprise:
storing the target data record based on a resource type of the target data record, the target data record comprising at least one of the following fields: transaction identifier, resource identifier, data source identifier, data number, timestamp, or raw data, wherein the transaction identifier indicates a data collection task to which the target data record belongs.

19. The device according to claim 18, wherein the actions further comprise:
receiving a request from a downstream system for retransmitting missing data, the request comprising a field of the missing data;
retrieving the missing data based on the field of the missing data; and
sending the retrieved missing data to the downstream system,
wherein the field of the missing data comprises at least one of:
the transaction identifier and a data number of the missing data, and
the data source identifier, the resource type, and a data loss time period that are pointed to by the missing data.

20. A computer program product tangibly stored on a non-volatile computer-readable medium and comprising machine-executable instructions, wherein the machine-executable instructions, when executed, cause a machine to perform actions comprising:
determining candidate distribution data and a data state of the candidate distribution data based on a collected target data record and a historical data record;
determining, based on the data state, data fields in the candidate distribution data that are to be distributed as distribution fields; and
processing the distribution fields to generate distribution data.
